(19) United States
(12) Patent Application Publication
(10) Pub. No.: US 2026/0183911 A1
(43) Pub. Date: Jul. 2, 2026

(54) POWER TAKE-OFF CONNECTION AND DISCONNECTION TOOL

(71) Applicant: Cristi Lington, Houston, TX (US)

(72) Inventor: Cristi Lington, Houston, TX (US)

(21) Appl. No.: 19/003,235

(22) Filed: Dec. 27, 2024

(51) Int. Cl. B25B 27/14; B60K 17/28; F16D 1/04

(52) U.S. Cl. CPC B25B 27/14; F16D 1/04; B60K 17/28

(57) ABSTRACT

Methods, structures, and devices for use with a positive locking latch of an implement input driveline (IID) coupler accepting a power take-off shaft, the positive locking latch comprising a spring-loaded pin. Devices comprise a pair of rigid arms connected at corresponding ends via a joint and having free opposite ends which define a jaw for grasping the IID coupler, the pair of rigid arms pivotally movable about the joint between an engaged position grasping the IID coupler and an open position; and a latching element engageable at the distal ends of the pair of rigid arms to constrain the pair of rigid arms in the engaged position; wherein the pair of rigid arms comprises: a retaining arm, and an engagement arm comprising a protrusion configured to depress the spring-loaded pin of the positive locking latch while the pair of rigid arms are in the engaged position.

### FIELD OF THE DISCLOSURE

This disclosure generally relates to devices and methods for facilitating the connection or disconnection of an implement provided with a drive shaft, such as an agricultural tool, with a power take-off system of a vehicle, such as an agricultural tractor.

### BACKGROUND OF THE DISCLOSURE

Agricultural vehicles, such as agricultural tractors, often include a power take-off (PTO) system which transfers power from the engine to a rotating PTO shaft that protrudes from the vehicle, sometimes referred to as the stub shaft. The system is designed to mechanically transfer power from the PTO shaft to an attached implement (such as, for example, a mower or auger) via an input driveline of the implement mechanically coupled to the PTO shaft, allowing the implement to operate without its own engine.

The part of the implement input driveline that connects to the stub shaft is referred to as the coupler. The coupler may comprise a yoke of an implement input driveline (IID) or an implement input connection (IIC), an adaptor, or any other IID component that connects to the stub shaft. The coupler at the near end of the IID includes a fitting that accepts the PTO shaft. The PTO shaft and the coupler have mating fittings. For example, the cross section of the PTO shaft may be square or splined. The coupler connecting with the PTO shaft is shaped to receive and couple with the PTO shaft so as to rotate in concert with the PTO shaft. The coupler of the implement input driveline (IID) is configured to remain in place until the implement is no longer needed. To this end, the coupler includes a locking mechanism that prevents longitudinal movement of the coupler with respect to the PTO shaft while engaged. One popular type of locking mechanism comprises a positive locking latch featuring a spring loaded pin which must be depressed in order to move the coupler on or off of the stub shaft.

For example, referring to U.S. Pat. No. 3,240,519 to Weasler, incorporated herein by reference, the PTO shaft may be splined and may include at least one peripheral channel cut into the splines. In another embodiment, the transverse cross section of the inner shaft element is square and the peripheral channel may be cut into the corners of the square. In either case, a dowel comprises a cylindrical portion fitting a blind bore in which it is reciprocable and urged by a spring to a position in which a tapered surface of the dowel seats in the channel segment in the spline or corner of the inner shaft element, thus locking the inner shaft element in place. A push button connected with the dowel by means of a neck of limited radius enables the dowel to be displaced against the bias of the spring. When the reduced neck registers with the spline or corner of the inner shaft element, there is nothing to obstruct the free movement of a complementary socket of an outer shaft element to and from the inner shaft element.

### SUMMARY OF THE DISCLOSURE

In aspects, the present disclosure is related to facilitating the connection or disconnection of an implement provided with a drive shaft, such as an agricultural tool, with a power take-off system of a vehicle, such as an agricultural tractor. Aspects include devices for use with a positive locking latch of an implement input driveline (IID) coupler accepting a power take-off shaft, where the positive locking latch comprises a spring-loaded pin. The coupler may comprise at least one of: i) a yoke and ii) an adaptor. The spring-loaded pin may be depressed to disengage the positive locking latch. Devices may include a pair of rigid arms connected at corresponding ends via a joint and having free opposite ends which define a jaw for grasping the IID coupler, the pair of rigid arms pivotally movable about the joint between an engaged position grasping the IID coupler and an open position. Devices may include a latching element engageable at the distal ends of the pair of rigid arms to constrain the pair of rigid arms in the engaged position. The latching element may comprise a tension member and a releasable fastener. The latching element may comprise at least one of: i) a toggle latch; ii) a threaded fastener; iii) a ratcheted quick release mechanism.

The pair of rigid arms may include: i) a retaining arm, and ii) an engagement arm comprising a protrusion configured to depress the spring-loaded pin of the positive locking latch while the pair of rigid arms are in the engaged position. Each arm of the pair of rigid arms may be semi-arcuate. The retaining arm may define a cavity for receiving the spring-loaded pin. The device may be adapted to secure a distal end of a first semi-arcuate rigid arm against a distal end of the second semi-arcuate rigid arm.

Each arm of the pair of rigid arms may comprise an upper frame member and a lower frame member. The lower frame members of each arm of the pair of rigid arms may comprise a latching shoulder for engaging the latching element. The upper frame members of each arm of the pair of rigid arms may be semi-arcuate. Upper sections of the upper frame members may be substantially semi-arcuate and lower sections of the upper frame members may be substantially parallel. The lower frame members of each arm of the pair of rigid arms may extend toward the midline of the tool and define an inner surface configured to grasp the IID coupler.

The engagement arm may comprise a rail and the protrusion may be detachable and comprises a t-slot configured to receive the rail for connection with the engagement arm. The protrusion may be detachable and may comprise a rail for connection and the engagement arm comprises a t-slot configured to receive the rail for connection with the protrusion. The protrusion may be detachable and may comprise a plurality of pins for connection and the engagement arm comprises a plurality of ports configured to receive the pins.

Examples of some features of the disclosure may be summarized rather broadly herein in order that the detailed description thereof that follows may be better understood and in order that the contributions they represent to the art may be appreciated.

### BRIEF DESCRIPTION OF THE DRAWINGS

For a detailed understanding of the present disclosure, reference should be made to the following detailed description of the embodiments, taken in conjunction with the accompanying drawings, in which like elements have been given like numerals, wherein:

FIGS. 1A & 1B illustrate power take-off (PTO) systems for use with devices in accordance with embodiments of the present disclosure;

FIG. 2 illustrates an agricultural tractor with a power take-off (PTO) shaft for use with devices in accordance with embodiments of the present disclosure;

FIG. 3 illustrates an implement input driveline (IID) with a coupler for use with devices in accordance with embodiments of the present disclosure;

FIGS. 4A-4C illustrate devices for disengaging a positive locking latch of an IID coupler accepting a power take-off shaft in accordance with embodiments of the disclosure;

FIG. 5 illustrates another device for disengaging a positive locking latch of an implement input driveline (IID) coupler accepting a power take-off shaft in accordance with embodiments of the disclosure;

FIGS. 6A & 6B illustrate a device for disengaging a positive locking latch of an IID coupler accepting a power take-off shaft in accordance with embodiments of the disclosure;

FIGS. 7A & 7B illustrate a device for disengaging a positive locking latch of an IID coupler accepting a power take-off shaft in accordance with embodiments of the disclosure.

### DETAILED DESCRIPTION

Aspects of the present disclosure relate to agricultural equipment and more particularly to a device for use with a positive locking latch of an implement input driveline (IID) coupler accepting a power take-off shaft. The device is configured to depress the spring-loaded pin of the positive locking latch so that there is nothing to obstruct the free movement of the IID coupler to and from the PTO shaft while the device is engaged.

As described above, the coupler of the IID is configured to remain in place until the implement is no longer needed, and includes a locking mechanism for this purpose. However, it is important to be able to disengage the locking mechanism when needed, because removing implements from the agricultural vehicle is a common occurrence. Various implements may be used on a tractor on a given day, for example.

Although positive locking latches featuring a depressible spring loaded pin were intended to be relatively easy to disengage, in practice this is not so. Owners of PTO-equipped vehicles are often frustrated by the challenges in connecting and disconnecting implements to the PTO system of their vehicle (e.g., a tractor). Implements are typically large and heavy, and they may be quite unwieldy. Such implements may include hay balers, forage choppers, large rotary mowers, elevators, grain augers, silage blowers, and so on.

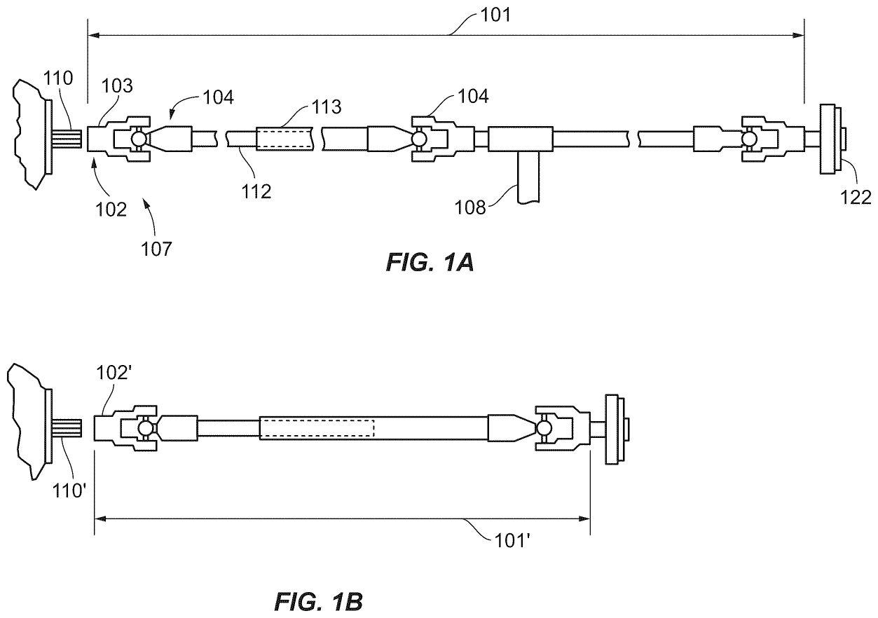

FIGS. 1A & 1B illustrate power take-off (PTO) systems for use with devices in accordance with embodiments of the present disclosure. FIG. 1A shows a PTO system implementing a pedestal connection as found on many types of pulled machinery. Implement input driveline (IID) 101, serving to transmit power between PTO shaft 110 and implement 122, includes a pedestal 108 and several universal joints 104 connected to respective square rigid shafts 112 which turn inside second shafts 113, which cooperate to transmit rotational power to the implement. A coupler connects the IID 101 to the PTO shaft 110 at the connection end 107 of the IID 101. The coupler 102 is a tubular outer shaft element, incorporated here as the hub of a yoke 103 of a flexible universal joint (“U-joint”) 104. The PTO shaft 110 comprises an inner shaft element detachably connected to the coupler 102. FIG. 1B shows a PTO system where the implement's input driveline (IID) 101′ connects directly to the tractor PTO shaft 110′.

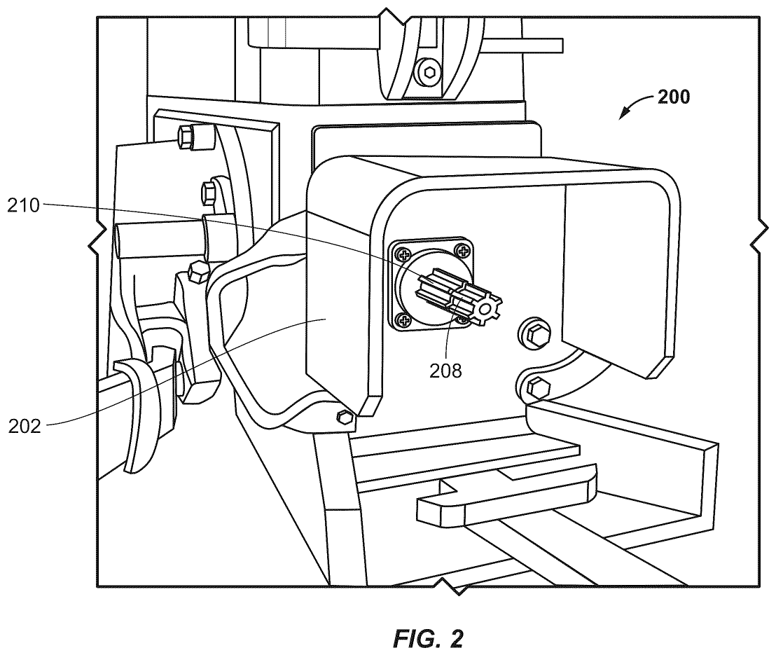

FIG. 2 illustrates an agricultural tractor with a power take-off (PTO) shaft for use with devices in accordance with embodiments of the present disclosure. Tractor 200 comprises a PTO shaft 210 featuring six splines 208. Shafts having more splines may be used for heavier tractors and implements. Tractor 200 further comprises a master safety shield 202 guarding splined PTO shaft 210 to avoid safety incidents involving the PTO shaft, such as, for example, clothing caught by an engaged PTO shaft.

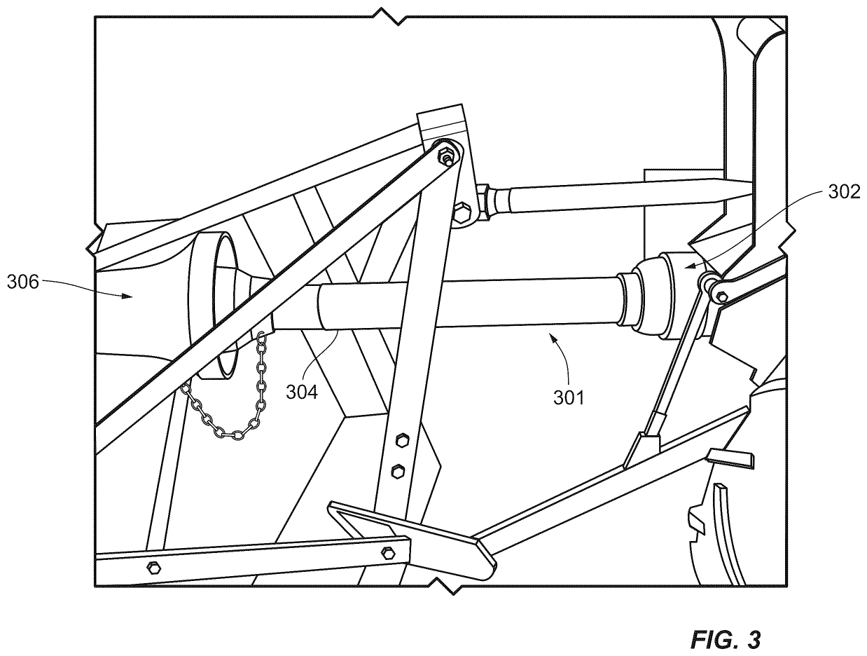

FIG. 3 illustrates an implement input driveline (IID) with a coupler for use with devices in accordance with embodiments of the present disclosure. Protruding pins and bolts associated with the IID, such as, for example, those used as connection locking devices, are particularly susceptible to snagging clothing worn by an operator. Implement input driveline (IID) 301 features a guard 302 at the connection end of the implement input driveline (IID), an integral-journal shield 304 which guards the IID shaft, and an implement input connection (IIC) shield 306 to protect the operator from the IIC, including the implement input stub and the connection to the IID.

The process of connecting an implement includes matching the phase of the splines with the spline channels and blindly aligning the coupler to the PTO shaft while supporting the weight of the driveline, and then translating the driveline onto the PTO shaft, which may require urging the implement to generate longitudinal motion. Problematically, the point of connection is typically shrouded in part by guards on both the driveline and the stub shaft, which further exacerbates the challenges of connection. The spring-loaded pin of the positive locking latch must be maintained in a depressed position by the finger of the operator connecting or disconnecting the coupler while aligning and translating the driveline, which is quite demanding for most people. Even depressing the pin by hand can be a challenge after years of wear and buildup accumulate on the locking mechanism. Even if successful, holding down the spring-loaded pin of the positive locking latch prevents the user from placing two hands at a position on the driveline beneficial for properly aligning the driveline (e.g., aft of the guard 302) and urging it into the correct position.

Thus, multiple attempts are often required in order to connect the implement to the PTO system. The process is time consuming and arduous. Many users report feeling exhausted by the time the implement is in place. The large number of attempts required to complete the task, along with the demanding nature of the task, can result in an increased risk of injuries to the user. The process is so difficult to complete that many owners buy additional vehicles to avoid having to switch implements. Thus, a solution to reduce the burden of switching implements would greatly increase safety and efficiency of implement use as well as making the experience less physically demanding and more pleasurable.

Previous solutions to difficulties in disengaging the locking mechanism include the use of various quick-connect adaptors. Each half of the adaptor is connected to the implement input driveline (IID) coupler and the power take-off shaft, respectively. The mating adaptor fittings opposite of the traditional fittings may then be coupled to one another. However, these adaptors do not meet the specifications of the original coupling, which may decrease the safety of implement use. In combination, these factors demand an improved solution.

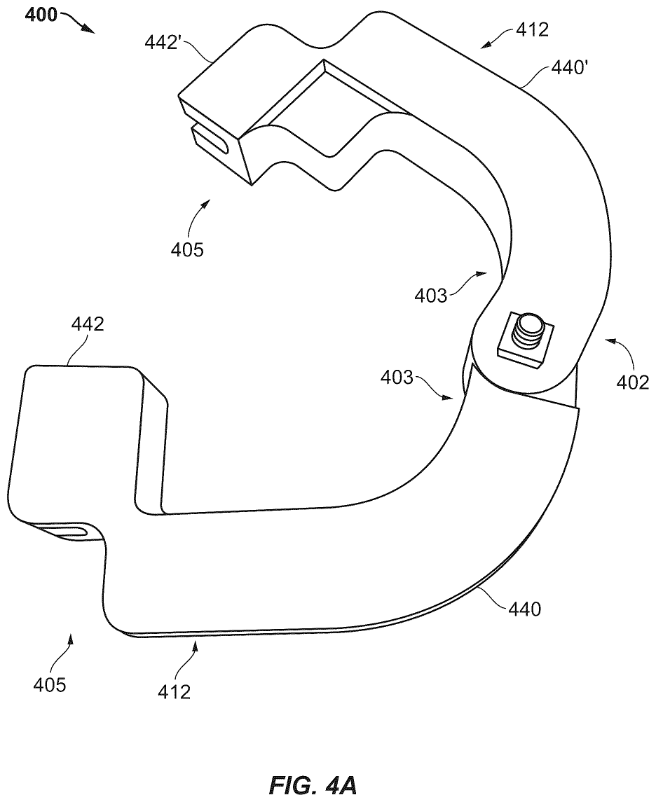

FIGS. 4A-4C illustrate devices for disengaging a positive locking latch of an IID coupler 490 having customary dimensions and accepting a power take-off shaft in accordance with embodiments of the disclosure. Device 400 comprises a pair of rigid arms 412 connected at corresponding ends 403 via a joint 402 and having free opposite ends 405 which define a jaw 406 for grasping the IID coupler. The pair of rigid arms 412 includes a retaining arm 414 and an engagement arm 416. The pair of rigid arms 412 are pivotally movable about the joint 402 between open position (FIG. 4A) and an engaged position grasping IID coupler 490 (FIG. 4B).

Device 400 further comprises a latching element 420 engageable at the opposite ends of the pair of rigid arms to constrain the pair of rigid arms in the engaged position. Latching element 420 may comprise a tension member 421, such as a cable, screw, or rod, and/or a releasable fastener 422. The fastener may include a ratchet and pawl to provide tension on the tension member. Alternatively, the latching element may comprise a toggle latch or a threaded fastener. Each arm 414, 416 comprises an upper frame member 440, 440′ and a lower frame member 442, 442′. Lower frame members may each comprise ribs 425a, 425b extending from free opposite ends 405 and defining a groove 437 in the distal faces 435 of the lower frame members configured to accept portions of the tension member 421 while in the engaged position. The pair of rigid arms is semi-arcuate. Lower frame members may each comprise a latching shoulder 446 for engaging the latching element. At the opposite end of the tension member 421 from the releasable fastener 422, the tension member may include a corresponding head 423 or shoulder to rest against the latching shoulder 446 to provide tension on the lower frame members in the engaged position.

Alternatively, tension member 421 may be connected with a joint to the lower frame member 442 at the opposite end of the tension member 421 from the releasable fastener 422. Referring to FIG. 4C, the joint may comprise a first opening 490a and a second opening 490b in respective ribs 425a, 425b and a pin 491 in the tension member 421, so that the tension member pivots about the pin 491 when the pin is seated in the first opening and the second opening.

Returning to FIG. 4B, the engagement arm 416 comprises a protrusion 430 configured to depress the spring-loaded pin of a positive locking latch while the pair of rigid arms are in the engaged position. IID coupler 490 includes ribs 495 forming a hand-guard for the spring-loaded pin of the positive locking latch. Protrusion 430 is so dimensioned as to be insertable through the space between the ribs 495 of IID coupler 490. Protrusion 430 exerts a force on the spring-loaded pin substantially parallel to the longitudinal axis of the pin.

Upper frame members 440, 440′ are semi-arcuate to better fit the cylindrical top surface of the coupler. Lower sections of the upper frame members may be substantially parallel. In moving the pair of rigid arms 412 pivotally about the joint 402 to an engaged position grasping IID coupler 490 and depressing the spring-loaded pin of the positive locking latch, the engagement arm 416 and protrusion may act in concert as a lever to increase mechanical advantage in depressing the pin. Device 400 may comprise at least one of steel, aluminum, plastic, low density polyethylene, high density polyethylene, nylon, polycarbonate, PVC, acrylic, and composites, or combinations of these.

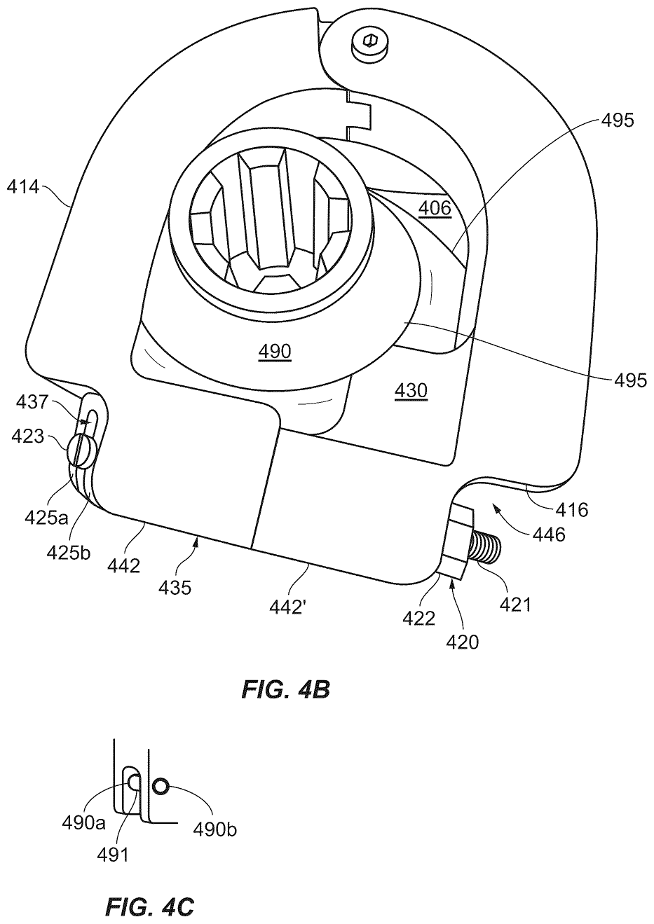

FIG. 5 illustrates another device for disengaging a positive locking latch of an implement input driveline (IID) coupler accepting a power take-off shaft in accordance with embodiments of the disclosure. Device 500 comprises a pair of rigid arms 512 connected at corresponding ends 503 via a joint 502 and having free opposite ends 505 which define a jaw 506 for grasping the IID coupler. Device 500 comprises a retaining arm 514 which defines a cavity 557 for receiving the spring-loaded pin. Each arm 514, 516 comprises an upper frame member 540, 540′ and a lower frame member 542, 542′. The lower frame members extend toward the midline of the tool 599 to form a hook. The lower frame members define an inner surface 547 configured to grasp the IID coupler. Upper sections 541, 541′ of the upper frame members are substantially semi-arcuate and lower sections 543, 543′ of the upper frame members are substantially parallel. Lower sections 543, 543′ of the upper frame members are substantially parallel with the midline. Device 500 is adapted to secure a distal end of a first semi-arcuate rigid arm against a distal end of the second semi-arcuate rigid arm, so that mating surfaces 560, 561 are urged into contact with one another, while protrusion 530 exerts a force on the spring-loaded pin substantially perpendicular to the midline.

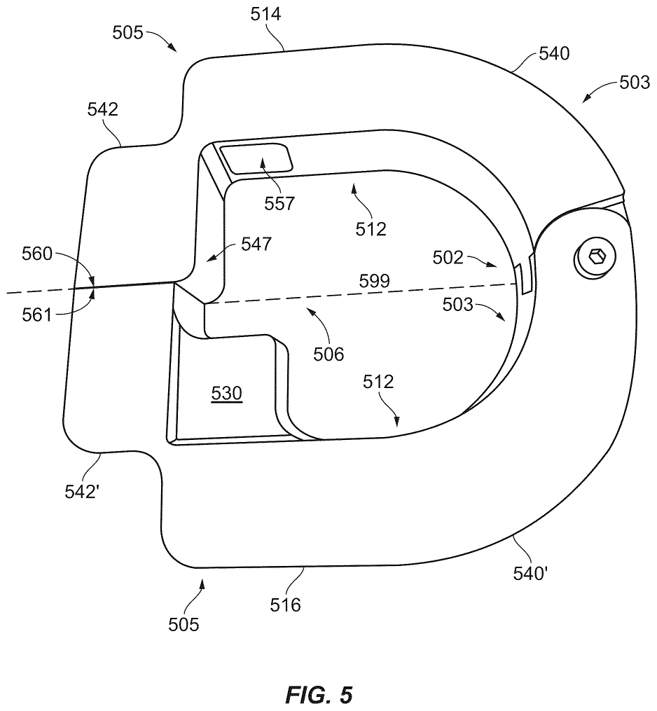

FIGS. 6A & 6B illustrate a device for disengaging a positive locking latch of an IID coupler accepting a power take-off shaft in accordance with embodiments of the disclosure. Engagement arm 616 is one of a pair of rigid arms functioning as described above. The engagement arm 616 comprises a detachable protrusion 630 configured to depress the spring-loaded pin of a positive locking latch when attached to engagement arm 616 and while the pair of rigid arms are in the engaged position. Detachable protrusion 630 comprises a plurality of coupling pins 631, 632 for connection with the engagement arm. The engagement arm 616 comprises a stub protrusion 640 having plurality of ports 641, 642 configured to receive the coupling pins for connection. The pins are held with a friction fit.

Depending on the dimensions of the coupler and the configuration (e.g., location) of the spring-loaded pin, either stub protrusion 640 or detachable protrusion 630 may be employed to depress the spring loaded pin. If the stub protrusion 640 is employed to depress the spring loaded pin, the detachable protrusion 630 may be left unattached.

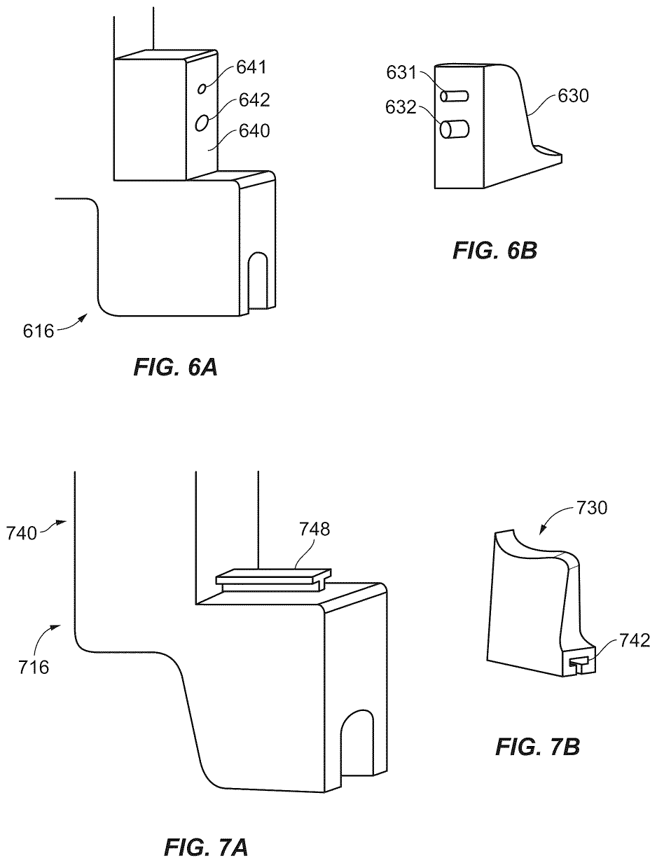

FIGS. 7A & 7B illustrate a device for disengaging a positive locking latch of an IID coupler accepting a power take-off shaft in accordance with embodiments of the disclosure. Engagement arm 716 is one of a pair of rigid arms functioning as described above. The engagement arm 716 comprises a detachable protrusion 730 configured to depress the spring-loaded pin of a positive locking latch when attached to engagement arm 716 and while the pair of rigid arms are in the engaged position. The engagement arm 716 comprises rail 748 and the detachable protrusion 730 comprises a t-slot 742 configured to receive the rail 748 for connection with the engagement arm. Detachable protrusion 730 is urged along the rail toward the upper frame member 740 until contacting an inner surface of the upper frame member 740. A group of detachable protrusions having various dimensions may be available for selection, individually or in combination, to improve the fit of the device. In other embodiments, the detachable protrusion comprises a rail for connection and the engagement arm comprises a t-slot configured to receive the rail for connection with the protrusion. Detachable protrusions may come in various shapes and utilize both pins and a rail for attachment, or use other attachment means, as would occur to those of skill in the art.

While the foregoing disclosure is directed to the one mode embodiments of the disclosure, various modifications will be apparent to those skilled in the art. It is intended that all variations be embraced by the foregoing disclosure. The present disclosure is to be taken as illustrative rather than as limiting the scope or nature of the claims below. Numerous modifications and variations will become apparent to those skilled in the art after studying the disclosure, including use of equivalent functional and/or structural substitutes for elements described herein, and/or use of equivalent functional actions for actions described herein. Such insubstantial variations are to be considered within the scope of the claims below.

Given the above disclosure of general concepts and specific embodiments, the scope of protection is defined by the claims appended hereto. The issued claims are not to be taken as limiting Applicant's right to claim disclosed, but not yet literally claimed subject matter by way of one or more further applications including those filed pursuant to the laws of the United States and/or international treaty.

What is claimed is:

1. A device for use with a positive locking latch of an implement input driveline (IID) coupler accepting a power take-off shaft, the positive locking latch comprising a spring-loaded pin, the device comprising:
a pair of rigid arms connected at corresponding ends via a joint and having free opposite ends which define a jaw for grasping the IID coupler, the pair of rigid arms pivotally movable about the joint between an engaged position grasping the IID coupler and an open position; and
a latching element engageable at the distal ends of the pair of rigid arms to constrain the pair of rigid arms in the engaged position;
wherein the pair of rigid arms comprises: i) a retaining arm, and ii) an engagement arm comprising a protrusion configured to depress the spring-loaded pin of the positive locking latch while the pair of rigid arms are in the engaged position.

2. The device of claim 1, wherein the retaining arm defines a cavity for receiving the spring-loaded pin.

3. The device of claim 1, wherein each arm of the pair of rigid arms comprises an upper frame member and a lower frame member.

4. The device of claim 3, wherein the lower frame members of each arm of the pair of rigid arms comprises a latching shoulder for engaging the latching element.

5. The device of claim 3, wherein the upper frame members of each arm of the pair of rigid arms is semi-arcuate.

6. The device of claim 1, wherein each arm of the pair of rigid arms comprises an upper frame member and a lower frame member, the lower frame members of each arm of the pair of rigid arms extending toward the midline of the tool and defining an inner surface configured to grasp the IID coupler.

7. The device of claim 1, wherein each arm of the pair of rigid arms is semi-arcuate.

8. The device of claim 7, wherein the device is adapted to secure a distal end of a first semi-arcuate rigid arm against a distal end of the second semi-arcuate rigid arm.

9. The device of claim 1, wherein the coupler comprises at least one of: i) a yoke and ii) an adaptor.

10. The device of claim 1, wherein the latching element comprises a tension member and a releasable fastener.

11. The device of claim 1, wherein the latching element comprises at least one of: i) a toggle latch; ii) a threaded fastener; iii) a ratcheted quick release mechanism.

12. The device of claim 1, wherein the engagement arm comprises a rail and the protrusion is detachable and comprises a t-slot configured to receive the rail for connection with the engagement arm.

13. The device of claim 1, wherein the protrusion is detachable and comprises a rail for connection and the engagement arm comprises a t-slot configured to receive the rail for connection with the protrusion.

14. The device of claim 1, wherein the protrusion is detachable and comprises a plurality of pins for connection and the engagement arm comprises a plurality of ports configured to receive the pins.

15. The device of claim 1, wherein each arm of the pair of rigid arms comprises an upper frame member and a lower frame member, wherein upper sections of the upper frame members are substantially semi-arcuate and lower sections of the upper frame members are substantially parallel.
